(19) United States
(12) Patent Application Publication
(10) Pub. No.: US 2026/0279885 A1
(43) Pub. Date: Sep. 17, 2026

(54) ELECTRODE PLATE STACKING APPARATUS

(71) Applicant: SAMSUNG SDI CO., LTD., Yongin-si (KR)

(72) Inventors: Hye Bin PARK, Suwon-si (KR); Joon Kil KIM, Suwon-si (KR); Sung Won LEE, Suwon-si (KR)

(21) Appl. No.: 19/537,245

(22) Filed: Feb. 11, 2026

(30) Foreign Application Priority Data
Mar. 14, 2025 (KR) 10-2025-0033456

(51) Int. Cl. H01M 10/052; H01M 10/04; H01M 10/0525; H01M 50/536

(52) U.S. Cl. CPC H01M 10/052; H01M 10/0404; H01M 10/0413; H01M 10/0431; H01M 10/0525; H01M 50/536

(57) ABSTRACT

An electrode plate stacking apparatus includes a first supplier configured to supply a first electrode plate, a second supplier spaced apart from the first supplier and configured to supply a second electrode plate, a stage configured to sequentially pass through the first supplier and the second supplier such that the first electrode plate and the second electrode plate are alternately stacked, and a transferer connected to the stage and configured to transfer the stage.

### CROSS-REFERENCE TO RELATED APPLICATION

The present application claims priority to and the benefit of Korean Patent Application No. 10-2025-0033456, filed on Mar. 14, 2025 in the Korean Intellectual Property Office, the entire disclosure of which is incorporated herein by reference.

### BACKGROUND

### 1. Field

Aspects of embodiments of the present disclosure relate to an electrode plate stacking apparatus.

### 2. Description of the Related Art

In general, due to the recent proliferation of electronic devices using batteries, such as mobile phones, notebook computers, and electric vehicles, the demand for secondary batteries having high energy density and high capacity has rapidly increased. Accordingly, research and development for improving the performance of a lithium secondary battery are being actively conducted.

A lithium secondary battery is a battery including a positive electrode and a negative electrode including an active material capable of intercalating and deintercalating lithium ions, and an electrolyte solution, and generates energy through oxidation/reduction reactions when lithium ions are intercalated/deintercalated at the positive and negative electrodes.

Secondary batteries may be classified into winding-type secondary batteries and stacked-type secondary batteries according to a shape thereof. The winding-type secondary battery may be manufactured by continuously winding a positive electrode plate, a negative electrode plate, and a separator together. The stacked-type secondary battery may be formed by alternately stacking positive electrode plates and negative electrode plates, which have been cut to a certain (e.g., predetermined) size, with separators interposed therebetween.

The above-described information disclosed in the technology that forms the background of the present disclosure is provided to improve understanding of the background of the present disclosure, and thus may include information that does not constitute the related art.

### SUMMARY

According to an aspect of embodiments of the present disclosure, an electrode plate stacking apparatus capable of improving the efficiency of a stacking operation of electrode plates is provided.

The above and other aspects and features of the present disclosure will be described in or will be apparent from the following description of some embodiments of the present disclosure.

According to one or more embodiments of the present disclosure, an electrode plate stacking apparatus includes a first supplier configured to supply a first electrode plate, a second supplier spaced apart from the first supplier and configured to supply a second electrode plate, a stage configured to sequentially pass through the first supplier and the second supplier such that the first electrode plate and the second electrode plate are alternately stacked, and a transferer connected to the stage and configured to transfer the stage.

The transferer may include a transfer roller, a transfer member arranged to surround the transfer roller and configured to circulate along a circumference of the transfer roller, and a connection member configured to connect the transfer member and the stage.

The stage may include a plurality of stages arranged along a movement path of the transfer member.

The transfer member may include a first transfer line configured to transfer the stage in a first direction, and the first supplier may include a plurality of first supply conveyors configured to supply the first electrode plate onto the stage transferred in the first direction.

The plurality of first supply conveyors may be arranged in the first direction.

Each of the first supply conveyors may include a pair of first supply rails configured to transfer the first electrode plate in a second direction intersecting the first direction, and a first rail hole located between the pair of first supply rails, the stage may pass through the first rail hole in the first direction, and the first electrode plate may be stacked on the stage that has passed through the first rail hole.

The first transfer line may be located inside the first rail hole.

Each of the first supply conveyors may further include first support members extending from the first supply rails toward the first rail hole and configured to support the first electrode plate.

The pair of first supply rails may face each other in a third direction intersecting the first direction and the second direction, and the first support members may be movably connected to the first supply rails in the third direction and a direction opposite to the third direction.

The second supplier may include a plurality of second supply conveyors configured to supply the second electrode plate onto the stage transferred in the first direction.

The plurality of second supply conveyors may be arranged in the first direction.

The first supply conveyors and the second supply conveyors may be alternately arranged in the first direction.

Each of the second supply conveyors may include a pair of second supply rails configured to transfer the second electrode plate in a second direction intersecting the first direction, and a second rail hole located between the pair of second supply rails, the stage may pass through the second rail hole in the first direction, and the second electrode plate may be stacked on the stage that has passed through the second rail hole.

Each of the second supply conveyors may further include second support members extending from the second supply rails toward the second rail hole and configured to support the second electrode plate.

The connection member may include a balancing member configured to rotatably support the stage with respect to the transfer member.

The connection member may include a position adjusting member configured to adjust a position of the stage.

The first electrode plate and the second electrode plate may be alternately stacked on the stage to form an electrode plate stack, and the electrode plate stacking apparatus may further include a discharge member configured to discharge the electrode plate stack from the stage.

The transfer member may include a first transfer line configured to transfer the stage in a first direction, and a second transfer line connected to the first transfer line and configured to transfer the stage in a direction opposite to the first direction, and the discharge member may include a gripper configured to separate the electrode plate stack from the stage transferred in the direction opposite to the first direction, and a gripper transfer member connected to the gripper and configured to transfer the gripper.

The gripper may include a fork portion facing a stage hole that passes through the stage in the first direction, and as the stage is transferred in the direction opposite to the first direction, the fork portion may pass through the stage hole, and the electrode plate stack may be seated on the fork portion.

The electrode plate stacking apparatus may further include a detector configured to detect the first electrode plate, the second electrode plate, and the stage, and a controller configured to control operations of the first supplier, the second supplier, and the transferer based on information detected by the detector.

### BRIEF DESCRIPTION OF THE DRAWINGS

The drawings included with this specification illustrate some embodiments of the present disclosure, and further describe aspects and features of the present disclosure together with the detailed description of the present disclosure. However, the present disclosure is not be construed as being limited to the drawings.

FIG. 1 is a view schematically illustrating a configuration of an electrode plate stacking apparatus according to an embodiment of the present disclosure;

FIG. 2 is a side view schematically illustrating configurations of a first supply unit and a second supply unit according to an embodiment of the present disclosure;

FIG. 3 is a perspective view schematically illustrating configurations of the first supply unit and the second supply unit according to an embodiment of the present disclosure;

FIG. 4 is a plan view schematically illustrating a configuration of a first support member according to an embodiment of the present disclosure;

FIG. 5 is a view schematically illustrating an installation state of a stage according to an embodiment of the present disclosure;

FIG. 6 is a view schematically illustrating a configuration of the stage according to an embodiment of the present disclosure;

FIG. 7 is a front view schematically illustrating a configuration of a transfer unit according to an embodiment of the present disclosure;

FIG. 8 is a side view schematically illustrating a configuration of the transfer unit according to an embodiment of the present disclosure;

FIG. 9 is a view illustrating a state in which the stage is transferred from a first transfer line to a second transfer line according to an embodiment of the present disclosure;

FIG. 10 is a block diagram schematically illustrating configurations of a detection member and a control member according to an embodiment of the present disclosure;

FIGS. 11 and 12 are views schematically illustrating a process in which the electrode plate stacking apparatus according to an embodiment stacks a first electrode plate and a second electrode plate;

FIG. 13 is a block diagram schematically illustrating a configuration of a discharge member according to an embodiment of the present disclosure;

FIG. 14 is a perspective view schematically illustrating a configuration of the discharge member according to an embodiment of the present disclosure;

FIG. 15 is a perspective view schematically illustrating a configuration of a gripper according to an embodiment of the present disclosure; and

FIGS. 16 to 19 are views schematically illustrating a process in which the electrode plate stacking apparatus according to an embodiment of the present disclosure discharges an electrode plate stack.

### DETAILED DESCRIPTION

Herein, some embodiments of the present disclosure will be described in further detail with reference to the accompanying drawings. The terms or words used in this specification and claims are not to be construed as being limited to the usual or dictionary meaning and are to be interpreted as having meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not necessarily represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer, or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element, or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.”

Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part, or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

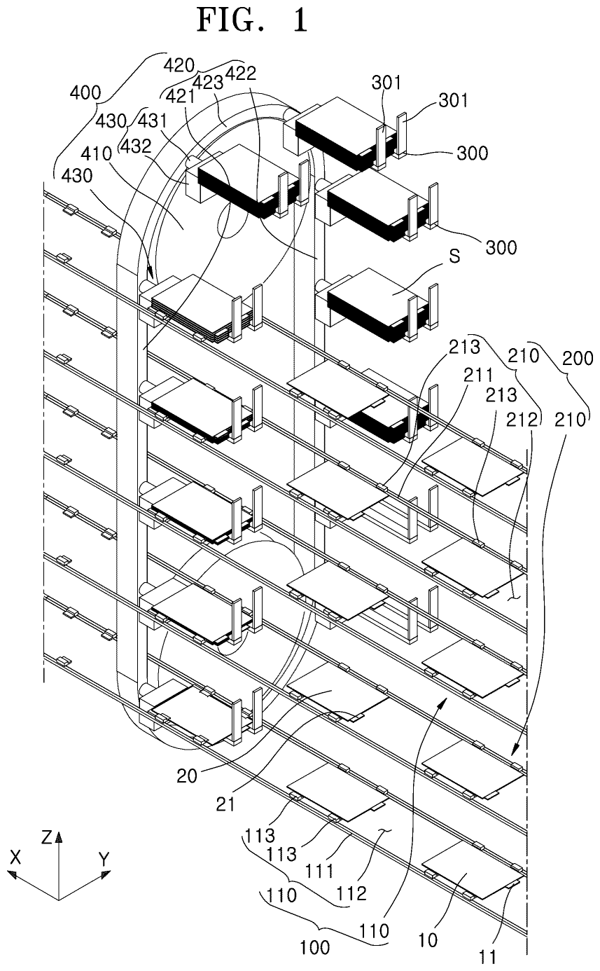

FIG. 1 is a view schematically illustrating a configuration of an electrode plate stacking apparatus according to an embodiment of the present disclosure.

Referring to FIG. 1, the electrode plate stacking apparatus according to an embodiment includes a first supply unit, or first supplier, 100, a second supply unit, or second supplier, 200, a stage 300, and a transfer unit, or transferer, 400.

In the following description, a first direction is illustrated as a Z-axis direction based on FIG. 1, a second direction is illustrated as an X-axis direction based on FIG. 1, and a third direction is illustrated as a Y-axis direction based on FIG. 1.

The first supply unit 100 may supply a first electrode plate 10.

In an embodiment, the first electrode plate 10 may be, for example, a positive electrode plate constituting an electrode assembly of a secondary battery. The first electrode plate 10 may be cut to a set length by a notching process and may have the form of a thin foil. The first electrode plate 10 may be formed of an electrically conductive material, such as copper, a copper alloy, nickel, a nickel alloy, aluminum, or an aluminum alloy.

At least a portion of the first electrode plate 10 may be coated with a first active material layer. The first active material layer may be applied to both, or opposite, surfaces of the first electrode plate 10, or to only one surface thereof.

In an embodiment, for example, the first electrode plate 10 is a positive electrode plate, and the first active material layer may include a positive electrode active material.

The positive electrode active material may include a compound (lithiated intercalation compound) capable of reversibly intercalating and deintercalating lithium. In an embodiment, the positive electrode active material may include one or more types of composite oxides of lithium and a metal selected from cobalt, manganese, nickel, iron, and a combination thereof.

The first active material layer may further include a positive electrode conductive material and a positive electrode binder.

The positive electrode conductive material imparts conductivity to the first active material layer, and any suitable electrically conductive material that does not cause a chemical change in the battery may be used. Examples of the positive electrode conductive material may include a carbon-based material, such as natural graphite, artificial graphite, carbon black, acetylene black, Ketjen black, carbon fibers, carbon nanofibers, carbon nanotubes, and the like, a metal-based material in the form of a metal powder or metal fibers including copper, nickel, aluminum, silver, and the like, a conductive polymer, such as a polyphenylene derivative, or a mixture thereof.

Examples of the positive electrode binder may include a non-aqueous binder, an aqueous binder, a dry binder, or a combination thereof.

The first electrode plate 10 may include a first tab 11.

The first tab 11 may be connected to the first electrode plate 10 and may protrude outward from the first electrode plate 10.

The first tab 11 according to an embodiment may have the form of a foil extending from the first electrode plate 10 in a direction opposite to the second direction. In an embodiment, the first tab 11 may have a generally rectangular shape. However, the shape and extension direction of the first tab 11 are not limited thereto and may be variously modified.

In an embodiment, the first tab 11 may be integrally formed with the first electrode plate 10. For example, the first tab 11 may be a remaining portion of the first electrode plate 10 after cutting or removing a partial region of the first electrode plate 10 through a notching process or the like. In an embodiment, the first tab 11 may be fabricated separately from the first electrode plate 10 and then connected thereto by welding or the like. In an embodiment, a material of the first tab 11 may be the same as the material of the first electrode plate 10.

In the drawings, one first tab 11 is illustrated as an example, but a number of first tabs 11 is not limited thereto and may be variously modified to include two, three, or more.

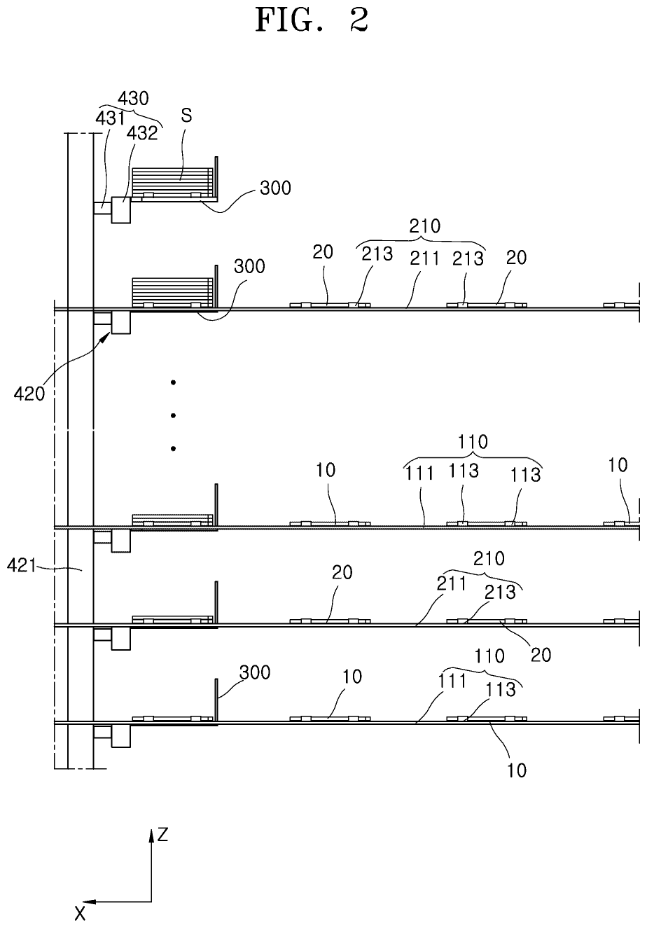

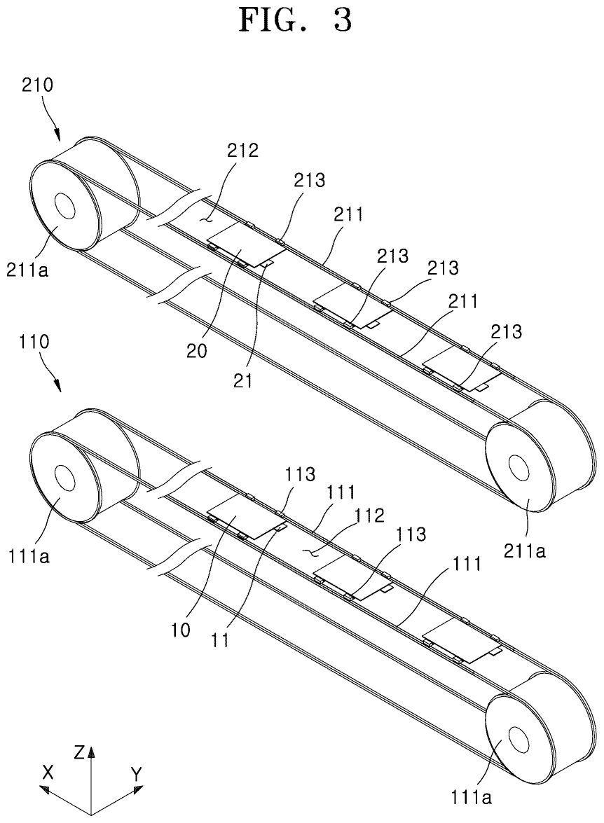

FIG. 2 is a side view schematically illustrating configurations of the first supply unit and the second supply unit according to an embodiment of the present disclosure; and FIG. 3 is a perspective view schematically illustrating configurations of the first supply unit and the second supply unit according to an embodiment of the present disclosure.

Referring to FIGS. 1 to 3, the first supply unit 100 according to an embodiment may include a first supply conveyor 110.

The first supply conveyor 110 may continuously supply the first electrode plates 10 onto a transfer path of the stage 300.

A plurality of first supply conveyors 110 may be provided. The plurality of first supply conveyors 110 may be arranged at intervals (e.g., predetermined intervals) in the first direction.

Each of the first supply conveyors 110 according to an embodiment may include a first supply rail 111 and a first rail hole 112.

The first supply rail 111 may transfer the first electrode plate 10 in the second direction.

The first supply rail 111 according to an embodiment may have a form of a belt or chain forming a closed loop. The first supply rail 111 may circulate along a closed-loop path and may continuously transfer a plurality of first electrode plates 10 in the second direction.

As an example, a first supply roller 111a configured to provide a driving force to the first supply rail 111 may be disposed inside the first supply rail 111.

The first supply roller 111a may have a form of a roller or sprocket that is rotatable about a central axis thereof. The central axis of the first supply roller 111a may be disposed parallel to the third direction. The first supply roller 111a may be rotated by receiving a rotational force from a driving device, such as a motor. In an embodiment, a pair of first supply rollers 111a may be provided. The pair of first supply rollers 111a may be spaced by a distance (e.g., a predetermined distance) apart from each other in the second direction. Circumferential surfaces of the pair of first supply rollers 111a may be in contact (e.g., close contact) with or engaged with an inner side surface of the first supply rail 111.

When the first supply rollers 111a rotate, an upper region of the first supply rail 111 may move in the second direction, and a lower region of the first supply rail 111 may move in a direction opposite to the second direction. Accordingly, the first supply rail 111 may circulate in an endless track manner along the circumferential surfaces of the first supply rollers 111a.

A pair of first supply rails 111 may be provided. The pair of first supply rails 111 may be disposed to be spaced by a distance (e.g., a predetermined distance) apart from each other in the third direction.

The first rail hole 112 may be disposed between the pair of first supply rails 111. The first rail hole 112 may provide a path for the stage 300 to pass between the pair of first supply rails 111.

The first rail hole 112 according to an embodiment may be, for example, an empty space formed between the pair of first supply rails 111. As the first supply rail 111 has a closed-loop structure, the first rail hole 112 may have the form of a hole that passes through both the upper and lower regions of the first supply rail 111 in the first direction.

The first supply conveyor 110 may further include a first support member 113.

The first support member 113 may be connected to the first supply rail 111 and may support the first electrode plate 10.

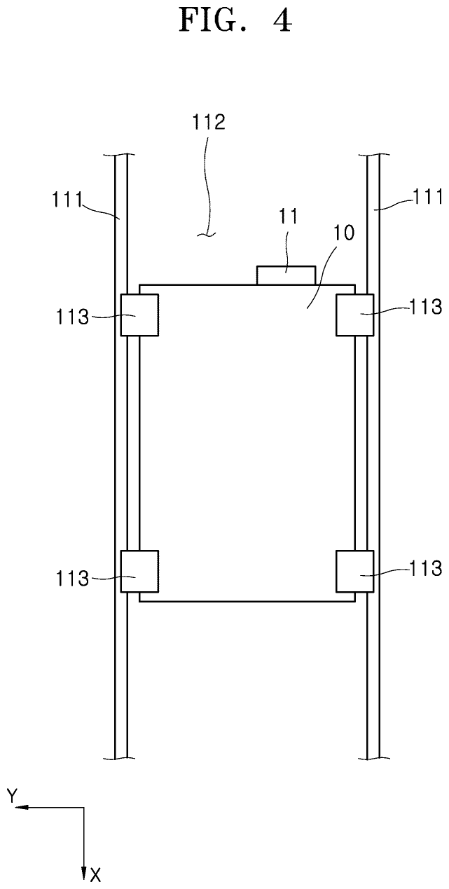

FIG. 4 is a plan view schematically illustrating a configuration of the first support member according to an embodiment of the present disclosure.

Referring to FIGS. 3 and 4, the first support member 113 according to an embodiment may protrude from the first supply rail 111 toward the first rail hole 112. A longitudinal direction of the first support member 113 may be disposed parallel to the third direction. When the first supply rail 111 moves, the first support member 113 may circulate along the closed-loop path together with the first supply rail 111.

A plurality of first support members 113 may be provided. The plurality of first support members 113 may be arranged at intervals (e.g., predetermined intervals) in an extension direction of the first supply rail 111.

Some of the plurality of first support members 113 may protrude from one of the pair of first supply rails 111 toward the first rail hole 112, and the remaining support members 113 may protrude from the other of the pair of first supply rails 111 toward the first rail hole 112.

In an embodiment, a distance between the pair of first supply rails 111 may be greater than a width of the first electrode plate 10 in the third direction.

The first electrode plate 10 may be supplied to upper regions of the first supply rails 111, which move in the second direction, by a suction device or the like. A lower surface of the first electrode plate 10 may be seated on the first support members 113 protruding from the first supply rails 111. Accordingly, when the first supply rails 111 move, the first electrode plate 10 may move in the second direction together with the upper regions of the first supply rails 111.

In an embodiment, the plurality of first electrode plates 10 may be repeatedly supplied to the upper regions of the first supply rails 111 at set time intervals. Accordingly, the plurality of first electrode plates 10 may be continuously transferred while being arranged at set intervals in the second direction.

The first support members 113 may be movably connected to the first supply rails 111. As an example, the first support members 113 may be connected to the first supply rails 111 to be reciprocally movable in the third direction and a direction opposite to the third direction. The first support members 113 may move in the third direction or the direction opposite to the third direction by receiving a driving force from a driving device, such as a motor or a cylinder.

The first support members 113 connected to the respective first supply rails 111 may move in opposite directions. As an example, when the first support members 113 connected to one of the first supply rails 111 move in the third direction, the first support members 113 connected to the other of the first supply rails 111 may move in the direction opposite to the third direction.

A length of the first support member 113 that protrudes inward from the first rail hole 112 may increase or decrease according to a moving direction of the first support member 113. As an example, as the first support members 113 connected to the respective first supply rails 111 move in directions approaching each other, the lengths of the first support members 113 protruding inward from the first rail hole 112 may increase. By contrast, as the first support members 113 connected to the respective first supply rails 111 move in directions away from each other, the lengths of the first support members 113 protruding inward from the first rail hole 112 may decrease. Accordingly, the first supply conveyor 110 according to an embodiment may transfer the first electrode plates 10 having various widths by the movement of the first support members 113.

As the first support members 113 connected to the respective first supply rails 111 move in directions away from each other by a distance greater than a set distance, the distance between the first support members 113 connected to the respective first supply rails 111 may exceed the width of the first electrode plate 10 in the third direction, and the first electrode plate 10 may be separated from the first support members 113. Accordingly, the first support members 113 may not collide with the stage 300 when the stage 300 passes through the first rail hole 112. In addition, the first support members 113 may prevent or substantially prevent the first electrode plate 10 from continuing to be transferred by the first supply rails 111 during a process in which the first electrode plate 10 is stacked on the stage 300.

The first supply conveyor 110 has been described above, by way of example, as including the first support member 113, but the first supply conveyor 110 is not limited thereto and may be configured to not include the first support member 113. In an embodiment, in FIG. 2, both, or opposite, sides of the first electrode plate 10 may be directly seated on the upper regions of the pair of first supply rails 111. The second supply unit 200 may be spaced apart from the first supply unit and may supply a second electrode plate 20.

In an embodiment, the second electrode plate 20 may be, for example, a negative electrode plate constituting an electrode assembly of a secondary battery. The second electrode plate 20 may be cut to a set length by a notching process and may have the form of a thin foil. The second electrode plate 20 may be formed of an electrically conductive material, such as copper, a copper alloy, nickel, a nickel alloy, aluminum, or an aluminum alloy.

At least a portion of the second electrode plate 20 may be coated with a second active material layer. The second active material layer may be applied to both, or opposite, surfaces of the second electrode plate 20, or to only one surface of the second electrode plate 20.

In an embodiment, for example, the second electrode plate 20 is a negative electrode plate, and the second active material layer may include a negative electrode active material.

The negative electrode active material may include a material that can reversibly intercalate/deintercalate lithium ions, a lithium metal, a lithium metal alloy, a material capable of doping and dedoping lithium, or a transition metal oxide.

The second active material layer may further include a negative electrode conductive material and a negative electrode binder.

The negative electrode conductive material imparts conductivity to the second active material layer, and any suitable electrically conductive material that does not cause a chemical change in the battery may be used. Examples of the negative electrode conductive material may include a carbon-based material, such as natural graphite, artificial graphite, carbon black, acetylene black, Ketjen black, carbon fibers, carbon nanofibers, carbon nanotubes, and the like, a metal-based material in the form of a metal powder or metal fibers including copper, nickel, aluminum, silver, and the like, a conductive polymer, such as a polyphenylene derivative, or a mixture thereof.

Examples of the negative electrode binder may include a non-aqueous binder, an aqueous binder, a dry binder, or a combination thereof.

The second electrode plate 20 may include a second tab 21.

The second tab 21 may be connected to the second electrode plate 20 and may protrude outward from the second electrode plate 20.

The second tab 21 according to an embodiment may have a form of a foil extending from the second electrode plate 20 in a direction opposite to the second direction. In an embodiment, the second tab 21 may have a generally rectangular shape. However, the shape and extension direction of the second tab 21 are not limited thereto and may be variously modified.

In an embodiment, the second tab 21 may be integrally formed with the second electrode plate 20. For example, the second tab 21 may be a remaining portion of the second electrode plate 20 after cutting or removing a partial region of the second electrode plate 20 through a notching process or the like. In an embodiment, the second tab 21 may be fabricated separately from the second electrode plate 20 and then connected thereto by welding or the like. In an embodiment, a material of the second tab 21 may be the same as the material of the second electrode plate 20.

In the drawings, one second tab 21 is illustrated as an example, but a number of second tabs 21 is not limited thereto and may be variously modified to include two, three, or more.

In an embodiment, the second supply unit 200 may transfer a separator together with the second electrode plate 20.

In an embodiment, the separator may be disposed to entirely cover both surfaces of the second electrode plate 20. The separator may be disposed to surround the second electrode plate 20 through a preceding process and may be supplied to the second supply unit 200 together with the second electrode plate 20.

The separator may be formed of polyethylene, polypropylene, polyvinylidene fluoride, or a multilayer film of two or more layers thereof, and may be made of a mixed multilayer film, such as a polyethylene/polypropylene double-layered separator, a polyethylene/polypropylene/polyethylene three-layered separator, and a polypropylene/polyethylene/polypropylene three-layered separator. The separator may include a porous substrate, and a coating layer including an organic material, an inorganic material, or a combination thereof located on one surface or both, or opposite, surfaces of the porous substrate.

The second supply unit 200 according to an embodiment may include a second supply conveyor 210.

The second supply conveyor 210 may continuously supply the second electrode plates 20 onto the transfer path of the stage 300.

A plurality of second supply conveyors 210 may be provided. The plurality of second supply conveyors 210 may be arranged at intervals (e.g., predetermined intervals) in the first direction.

In an embodiment, the first supply conveyors 110 and the second supply conveyors 210 may be alternately disposed in the first direction. Accordingly, the first supply conveyors 110 and the second supply conveyors 210 may allow the first electrode plates 10 and the second electrode plates 20 to be alternately stacked on the stage 300 that is continuously moved.

Each of the second supply conveyors 210 according to an embodiment may include a second supply rail 211 and a second rail hole 212.

The second supply rail 211 may transfer the second electrode plates 20 in the second direction.

The second supply rail 211 according to an embodiment may have a form of a belt or chain forming a closed loop. The second supply rail 211 may circulate along the closed-loop path and may continuously transfer a plurality of second electrode plates 20 in the second direction.

As an example, a second supply roller 211a configured to provide a driving force to the second supply rail 211 may be disposed inside the second supply rail 211.

The second supply roller 211a may have a form of a roller or sprocket that is rotatable about a central axis. The central axis of the second supply roller 211a may be disposed parallel to the third direction. The second supply roller 211a may be rotated by receiving a rotational force from a driving device, such as a motor. In an embodiment, a pair of second supply rollers 211a may be provided. The pair of second supply rollers 211a may be spaced by a distance (e.g., a predetermined distance) apart from each other in the second direction. Circumferential surfaces of the pair of second supply rollers 211a may be in contact (e.g., close contact) with or engaged with an inner side surface of the second supply rail 211.

When the second supply rollers 211a rotate, an upper region of the second supply rail 211 may move in the second direction, and a lower region of the second supply rail 211 may move in a direction opposite to the second direction. Accordingly, the second supply rail 211 may circulate in an endless track manner along the circumferential surfaces of the second supply rollers 211a.

In an embodiment, a pair of second supply rails 211 may be provided. The pair of second supply rails 211 may be disposed to be spaced by a distance (e.g., a predetermined distance) apart from each other in the third direction.

The second rail hole 212 may be disposed between the pair of second supply rails 211. The second rail hole 212 may provide a path through which the stage 300 passes between the pair of second supply rails 211.

The second rail hole 212 according to an embodiment may be, for example, an empty space formed between the pair of second supply rails 211. As the second supply rail 211 has a closed-loop structure, the second rail hole 212 may have the form of a hole that penetrates both the upper and lower regions of the second supply rail 211 in the first direction.

The second supply conveyor 210 may further include a second support member 213.

The second support member 213 may be connected to the second supply rail 211 and may support the second electrode plate 20.

The second support member 213 according to an embodiment may protrude from the second supply rail 211 toward the second rail hole 212. A longitudinal direction of the second support member 213 may be disposed parallel to the third direction. When the second supply rail 211 moves, the second support member 213 may circulate along the closed-loop path together with the second supply rail 211.

A plurality of second support members 213 may be provided. The plurality of second support members 213 may be arranged at intervals (e.g., predetermined intervals) in an extension direction of the second supply rail 211.

Some of the plurality of second support members 213 may protrude from one of the pair of second supply rails 211 toward the second rail hole 212, and the remaining support members 213 may protrude toward the second rail hole 212 from the other of the pair of second supply rails 211.

In an embodiment, a distance between the pair of second supply rails 211 may be greater than a width of the second electrode plate 20 in the third direction.

In an embodiment, the second electrode plate 20 may be supplied to the upper regions of the second supply rails 211, which move in the second direction, by a suction device or the like. The second electrode plate 20 may be supplied to the upper regions of the second supply rails 211 together with the separator. A lower surface of the second electrode plate 20 may be seated on the second support members 213 protruding from the second supply rails 211. Accordingly, when the second supply rails 211 move, the second electrode plate 20 may move in the second direction together with the upper regions of the second supply rails 211.

A plurality of second electrode plates 20 may be repeatedly supplied to the upper regions of the second supply rails 211 at set time intervals. Accordingly, the plurality of second electrode plates 20 may be continuously transferred while being arranged at set intervals in the second direction.

The second support members 213 may be movably connected to the second supply rails 211. As an example, the second support members 213 may be connected to the second supply rails 211 to be reciprocally movable in the third direction and in a direction opposite to the third direction. The second support members 213 may move in the third direction or the direction opposite to the third direction by receiving a driving force from a driving device, such as a motor or a cylinder.

The second support members 213 connected to the respective second supply rails 211 may move in opposite directions. As an example, when the second support members 213 connected to one of the second supply rails 211 moves in the third direction, the second support members 213 connected to the other of the second supply rails 211 may move in the direction opposite to the third direction.

A length of the second support member 213 protruding inward from the second rail hole 212 may increase or decrease depending on a moving direction of the second support member 213. As an example, as the second support members 213 connected to the respective second supply rails 211 move in directions approaching each other, the lengths of the second support members 213 protruding inward from the second rail hole 212 may increase. By contrast, as the second support members 213 connected to the respective second supply rails 211 move in directions away from each other, the lengths of the second support members 213 protruding inward from the second rail hole 212 may decrease. Accordingly, the second supply conveyor 210 according to an embodiment may transfer the second electrode plates 20 having various widths by the movement of the second support members 213.

As the second support members 213 connected to the respective second supply rails 211 move in directions away from each other by a distance greater than a set distance, the distance between the second support members 213 connected to the respective second supply rails 211 may exceed the width of the second electrode plate 20 in the third direction, and the second electrode plate 20 may be separated from the second support members 213. Accordingly, the second support members 213 may not collide with the stage 300 as the stage 300 passes through the second rail hole 212. In addition, the second support members 213 may prevent or substantially prevent the second electrode plate 20 from continuing to be transferred by the second supply rails 211 during a process in which the second electrode plate is stacked on the stage 300.

The stage 300 may provide a space in which the first electrode plate 10 and the second electrode plate 20 are stacked. The stage 300 may be transferred along a set transfer path by the transfer unit 400 and may perform a stacking operation of the first electrode plate 10 and the second electrode plate 20.

As an example, the stage 300 may sequentially pass through the first supply unit 100 and the second supply unit 200 such that the first electrode plate 10 and the second electrode plate 20 are alternately stacked thereon. In an embodiment, a portion of the transfer path of the stage 300 may overlap a supply path of the first electrode plate 10 provided by the first supply unit 100 and a supply path of the second electrode plate 20 provided by the second supply unit 200. The stage 300 may sequentially pass through the supply path of the first electrode plate 10 provided by the first supply unit 100 and the supply path of the second electrode plate 20 provided by the second supply unit 200. During this process, the first electrode plate 10 and the second electrode plate 20 may be alternately stacked on the stage 300 to form an electrode plate stack S.

In an embodiment, the electrode plate stack S may be, for example, an assembly of the first electrode plates 10 and the second electrode plates 20, in which at least one or more first electrode plates 10 and at least one or more second electrode plates 20 are alternately stacked.

A plurality of stages 300 may be provided. The plurality of stages 300 may be disposed to be spaced apart from each other. The plurality of stages 300 may be continuously transferred at set intervals along the same transfer path. In an embodiment, the plurality of stages 300 may be arranged at set intervals along a transfer path of any one stage 300. However, a number of stages 300 is not limited to that illustrated in the drawings and may be variously modified.

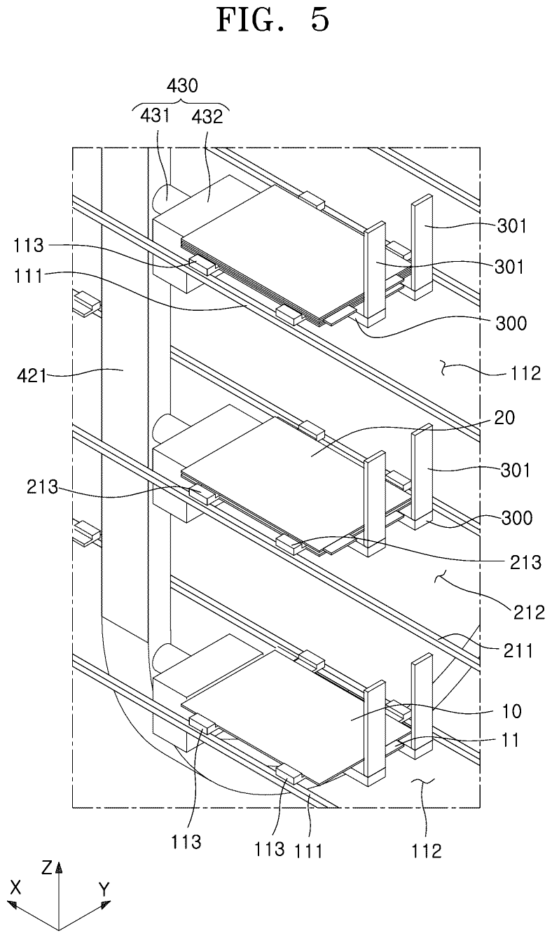

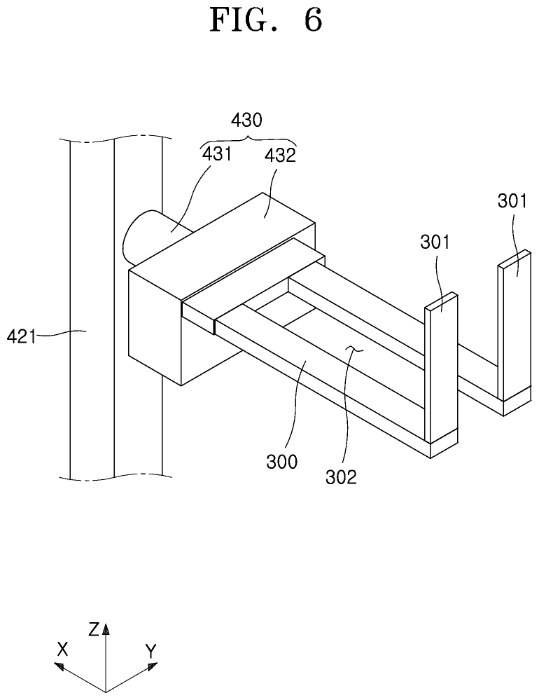

FIG. 5 is a view schematically illustrating an installation state of the stage according to an embodiment of the present disclosure; and FIG. 6 is a view schematically illustrating a configuration of the stage according to an embodiment of the present disclosure.

Referring to FIGS. 5 and 6, the stage 300 according to an embodiment may have a flat plate shape that is disposed perpendicular to the first direction. In an embodiment, an area of the stage 300 may be smaller than an area of each of the first electrode plate 10 and the second electrode plate 20. In an embodiment, the area of the stage 300 may be larger than the area of each of the first electrode plate 10 and the second electrode plate 20.

A first end portion of the stage 300 may be disposed to face the transfer unit 400, which will be described below. The first end portion of the stage 300 may be connected to the transfer unit 400.

A stacking guide 301 may be formed at a second end portion of the stage 300, the second end portion being located at a side opposite to the transfer unit 400.

The stacking guide 301 according to an embodiment may have a form of a rod extending in the first direction from the other end portion of the stage 300. A plurality of stacking guides 301 may be provided. The plurality of stacking guides 301 may be arranged at intervals (e.g., predetermined intervals) in the third direction. In FIG. 6, an example is illustrated in which two stacking guides 301 are formed, but the number of stacking guides 301 is not limited thereto and may be variously modified.

The stacking guides 301 may align positions of the first tab 11 and the second tab 21 during the process in which the first electrode plate 10 and the second electrode plate 20 are stacked on the stage 300. In an embodiment, as the first electrode plate 10 and the second electrode plate 20 are stacked on the stage 300, a side surface of the stacking guide 301 may be disposed to face a side surface of at least one of the first tab 11 and the second tab 21. The first tab 11, the stacking guide 301, and the second tab 21 may be alternately arranged in the third direction. A stacking guide 301 of the stacking guides 301 may be disposed between the first tab 11 and the second tab 21. Accordingly, the stacking guide 301 may prevent or substantially prevent misalignment in a stacking angle of the plurality of first electrode plates 10 and the plurality of second electrode plates 20 on the stage 300.

The transfer unit 400 may be connected to the stage 300 and may transfer the stage 300. The transfer unit 400 may vary the position of the stage 300 by a driving force of the transfer unit 400.

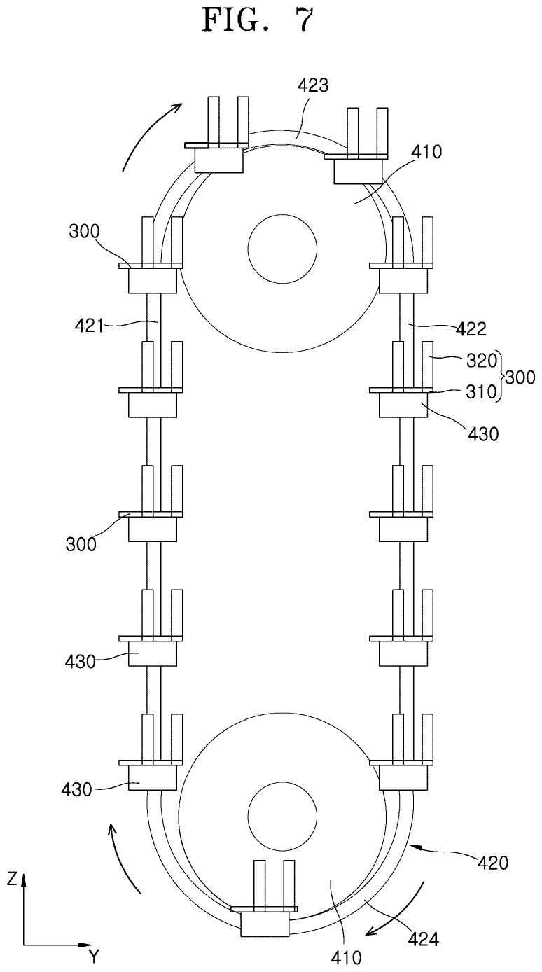

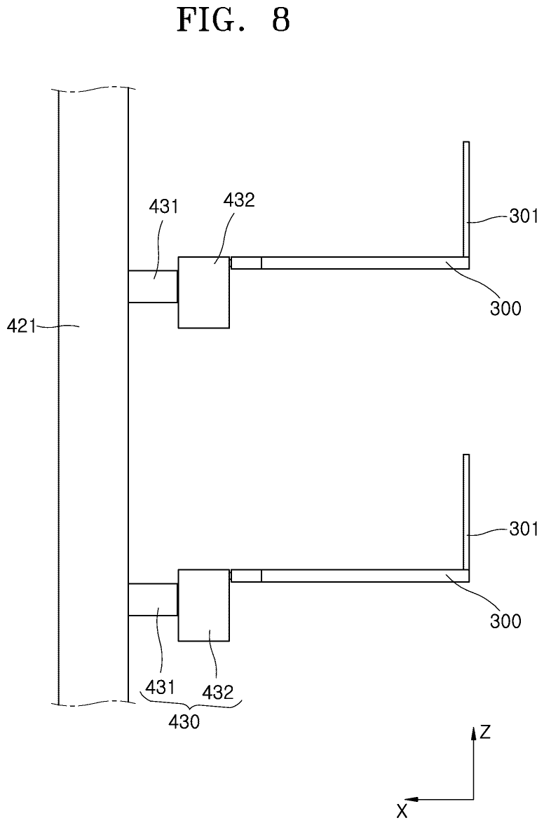

FIG. 7 is a front view schematically illustrating a configuration of the transfer unit according to an embodiment of the present disclosure; and FIG. 8 is a side view schematically illustrating a configuration of the transfer unit according to an embodiment of the present disclosure.

Referring to FIGS. 7 and 8, the transfer unit 400 according to an embodiment may include a transfer roller 410, a transfer member 420, and a connection member 430.

The transfer roller 410 may generate a driving force for moving the transfer member 420.

The transfer roller 410 according to an embodiment may have a form of a roller or sprocket that is rotatable about a central axis thereof. The central axis of the transfer roller 410 may be disposed parallel to the second direction. The transfer roller 410 may be connected to a driving device, such as an electric motor, and may be rotated by receiving a driving force from the driving device.

In an embodiment, a pair of transfer rollers 410 may be provided. The pair of transfer rollers 410 may be disposed to be spaced by a distance (e.g., a predetermined distance) apart from each other in the first direction.

The transfer member 420 may be disposed to surround the transfer rollers 410. When the transfer rollers 410 are driven, the transfer member 420 may circulate along circumferential surfaces of the transfer rollers 410.

The transfer member 420 may be connected to the stage 300 by the connection member 430. While circulating along the circumferential surfaces of the transfer rollers 410, the transfer member 420 may transfer the stage 300.

The transfer member 420 according to an embodiment may have a form of a belt or chain forming a closed loop.

As an example, the transfer member 420 may include a first transfer line 421, a second transfer line 422, a first transition line 423, and a second transition line 424.

The first transfer line 421 may transfer the stage 300 in the first direction.

The first transfer line 421 according to an embodiment may be disposed parallel to the first direction. The first transfer line 421 may be, for example, a partial region where the transfer member 420 moves in the first direction, among an entire region of the transfer member 420 that circulates along the circumferential surfaces of the transfer rollers 410.

The first transfer line 421 may be disposed inside the first rail hole 112 and the second rail hole 212. The first transfer line 421 may be disposed to sequentially pass through a plurality of first rail holes 112 and a plurality of second rail holes 212 alternatively arranged in the first direction. The first transfer line 421 may be disposed inside the first rail hole 112 between the pair of first supply rails 111, and may be spaced apart from the pair of first supply rails 111. The first transfer line 421 may be disposed inside the second rail hole 212 between the pair of second supply rails 211, and may be spaced apart from the pair of second supply rails 211.

Accordingly, the first supply conveyor 110 and the second supply conveyor 210 may supply the first electrode plate 10 and the second electrode plate 20, respectively, onto the stage 300 that is transferred in the first direction by the first transfer line 421.

The second transfer line 422 may transfer the stage 300 in a direction opposite to the first direction.

The second transfer line 422 according to an embodiment may be disposed parallel to the first direction. The second transfer line 422 may be, for example, a partial region where the transfer member 420 moves in the direction opposite to the first direction, among the entire region of the transfer member 420 that circulates along the circumferential surfaces of the transfer rollers 410.

The first transfer line 421 and the second transfer line 422 may be spaced by a distance (e.g., a predetermined distance) apart from each other in the third direction. The second transfer line 422 may be disposed outside the first supply conveyor 110 and the second supply conveyor 210.

The first transition line 423 may transfer the stage 300, which has passed through the first transfer line 421, to the second transfer line 422.

Both, or opposite, end portions of the first transition line 423 according to an embodiment may be connected to an upper end portion of the first transfer line 421 and an upper end portion of the second transfer line 422, respectively. The first transition line 423 may be, for example, an upper region of the transfer member 420 connecting the first transfer line 421 and the second transfer line 422, among the entire region of the transfer member 420 that circulates along the circumferences of the transfer rollers 410.

In an embodiment, the first transition line 423 may have an arc shape bent about the second direction. Accordingly, the stage 300 that has passed through the first transfer line 421 may be moved along the first transition line 423 and transferred to the second transfer line 422.

A circumferential surface of the transfer roller 410 of the pair of transfer rollers 410, which is disposed on the upper side, may be in contact (e.g., close contact) with or engaged with an inner surface of the first transition line 423. Accordingly, when the transfer roller 410 rotates, a rotational force thereof may be transmitted to the transfer member 420 through the first transition line 423, and the transfer member 420 may move along the circumferential surface of the transfer roller 410.

The second transition line 424 may transfer the stage 300, which has passed through the second transfer line 422, to the first transfer line 421.

Both, or opposite, end portions of the second transition line 424 according to an embodiment may be connected to a lower end portion of the first transfer line 421 and a lower end portion of the second transfer line 422, respectively. The second transition line 424 may be, for example, a lower region of the transfer member 420 connecting the first transfer line 421 and the second transfer line 422, among the entire region of the transfer member 420 that circulates along the circumferential surfaces of the transfer rollers 410.

In an embodiment, the second transition line 424 may have an arc shape bent about the second direction. Accordingly, the stage 300 that has passed through the second transfer line 422 may be moved along the second transition line 424 and transferred to the first transfer line 421.

A circumferential surface of the transfer roller 410 of the pair of transfer rollers 410, which is disposed on the lower side, may be in contact (e.g., close contact) with or engaged with an inner surface of the second transition line 424. Accordingly, when the transfer roller 410 rotates, a rotational force thereof may be transmitted to the transfer member 420 through the second transition line 424, and the transfer member 420 may move along the circumferential surface of the transfer roller 410.

The connection member 430 may connect the stage 300 and the transfer member 420. The connection member 430 may support the stage 300 with respect to the transfer member 420 and may transmit the driving force, which is generated by the movement of the transfer member 420, to the stage 300.

In an embodiment, the stage 300 may be disposed to face the transfer member 420 in the second direction. The connection member 430 may be disposed between the stage 300 and the transfer member 420. Both, or opposite, sides of the connection member 430 may be connected to the stage 300 and the transfer member 420, respectively.

When the transfer member 420 operates, the stage 300 may be circulated along a movement path of the transfer member 420 together with the transfer member 420 and the connection member 430. As an example, the stage 300 may be moved in the first direction by the first transfer line 421, transferred to the second transfer line 422 by the first transition line 423, moved in a direction opposite to the first direction by the second transfer line 422, and transferred again to the first transfer line 421 by the second transition line 424. This operation may be repeatedly performed.

The plurality of stages 300 may be arranged at intervals (e.g., set intervals) along the transfer member 420. As an example, at least one stage 300 may be disposed in front of each of the first transfer line 421, the second transfer line 422, the first transition line 423, and the second transition line 424. That is, some of the plurality of stages 300 may be disposed to face the first transfer line 421 in the second direction, others of the plurality of stages 300 may be disposed to face the second transfer line 422 in the second direction, still others of the plurality of stages 300 may be disposed to face the first transition line 423 in the second direction, and the remaining stages 300 may be disposed to face the second transition line 424 in the second direction.

A plurality of connection members 430 may be provided. Each of the connection members 430 may individually connect a different stage 300 to the transfer member 420. Accordingly, the plurality of stages 300 may be transferred while maintaining a set interval.

The connection member 430 according to an embodiment may include a balancing member 431 and a position adjusting member 432.

Herein, a case in which the connection member 430 includes both the balancing member 431 and the position adjusting member 432 will be described as an example. However, the connection member 430 is not limited thereto and may be configured to include only one of the balancing member 431 or the position adjusting member 432.

The balancing member 431 may rotatably support the stage 300 with respect to the transfer member 420. The balancing member 431 may maintain a constant installation angle of the stage 300 during the transfer process of the stage 300. Accordingly, the balancing member 431 may prevent or substantially prevent upper and lower surfaces of the stage 300 from being reversed or the stage 300 from tilting with respect to the second direction during the transfer process of the stage 300, thereby preventing or substantially preventing the first electrode plate 10 and the second electrode plate 20 from being separated from the stage 300.

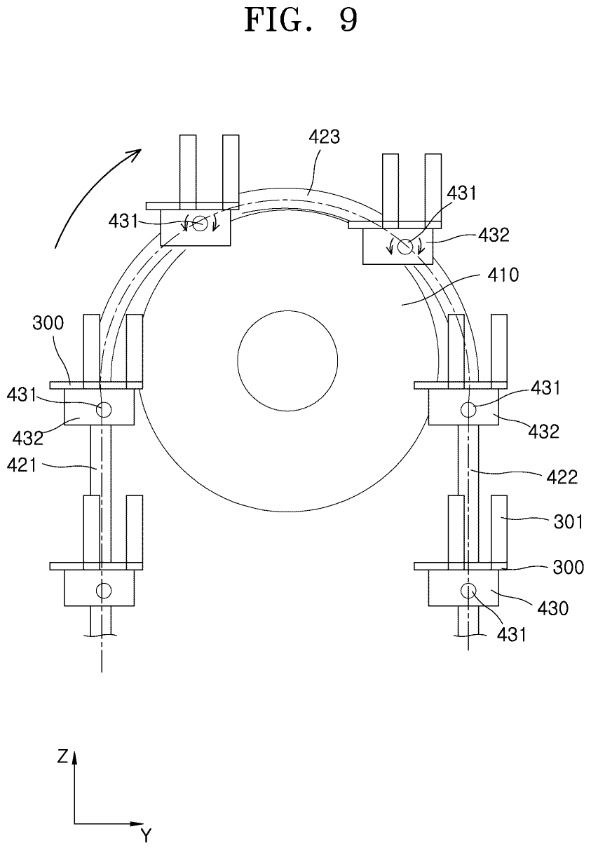

FIG. 9 is a view illustrating a state in which the stage is transferred from the first transfer line to the second transfer line according to an embodiment of the present disclosure.

Referring to FIGS. 7 to 9, the balancing member 431 according to an embodiment may extend from the transfer member 420 toward the stage 300. A longitudinal direction of the balancing member 431 may be disposed parallel to the first direction. In an embodiment, an end portion of the balancing member 431 may be indirectly connected to the stage 300 via the position adjusting member 432, which will be described below. However, the balancing member 431 is not limited thereto, and, in an embodiment, may be configured such that the end portion is directly connected to the stage 300.

The balancing member 431 may rotatably support the stage 300 about the second direction.

The balancing member 431 may guide the stage 300 to rotate in a clockwise or counterclockwise direction about the second direction during the operation of the transfer member 420, thereby maintaining the stage 300 in a state perpendicular to the first direction.

As an example, when the stage 300 enters the first transition line 423 or the second transition line 424, the stage 300 may become tilted with respect to the first direction due to bending angles of the first and second transition lines 423 and 424.

In this case, the stage 300 is rotatably supported about the second direction by the balancing member 431, and the stage 300 may relatively rotate with respect to the balancing member 431 in a direction that offsets the tilt by its own weight and maintain a state perpendicular to the second direction.

In the above, a case has been described in which the balancing member 431 according to an embodiment passively adjusts a rotation angle of the stage 300. However, embodiments are not limited thereto, and the balancing member 431 may be configured to actively adjust the rotation angle of the stage 300. As an example, the balancing member 431 may further include a driving device that is connected to the stage 300 and configured to generate a driving force to rotate the stage 300 in the clockwise or counterclockwise direction about the second direction, a rotation angle sensor configured to detect the rotation angle of the stage 300, and a control device configured to control the operation of the driving device based on angle information of the stage 300 detected by the rotation angle sensor.

The position adjusting member 432 may adjust the position of the stage 300.

The position adjusting member 432 according to an embodiment may be disposed between the stage 300 and the balancing member 431. Both, or opposite, sides of the position adjusting member 432 may be connected to the stage 300 and the balancing member 431, respectively.

The position adjusting member 432 may reciprocate the stage 300 in at least one of the first direction, the second direction, or the third direction. In an embodiment, the position adjusting member 432 may include any of various types of linear movement devices capable of linearly moving the stage 300, such as any of lead screws, ball screws, or cylinders, and a driving device that drives the linear movement device.

FIG. 10 is a block diagram schematically illustrating configurations of a detection member and a control member according to an embodiment of the present disclosure.

Referring to FIG. 10, the electrode plate stacking apparatus according to an embodiment may further include a detection member, or detector, 500 and a control member, or controller, 600.

The detection member 500 may detect the first electrode plate 10, the second electrode plate 20, and the stage 300.

The detection member 500 according to an embodiment may include at least one of an optical sensor, such as a vision sensor or a camera, which is capable of detecting a position, shape, or size of each of the first electrode plate 10, the second electrode plate 20, and the stage 300, and a speed sensor, which is capable of detecting a moving speed of each of the first electrode plate 10, the second electrode plate 20, and the stage 300.

In an embodiment, the detection member 500 may be spaced apart from the first supply unit 100, the second supply unit 200, the stage 300, and the transfer unit 400. In an embodiment, the detection member 500 may be coupled to at least one of the first supply unit 100, the second supply unit 200, the stage 300, and the transfer unit 400. The detection member 500 may be placed in any of various positions that do not interfere with the transfer of the first electrode plate 10, the second electrode plate 20, and the stage 300.

In an embodiment, a plurality of detection members 500 may be provided. Each of the detection members 500 may individually detect the first electrode plate 10 supplied by the first supply unit 100, the second electrode plate 20 transferred by the second supply unit 200, the plurality of stages 300, and the electrode plate stack S stacked on the stage 300. In an embodiment, the detection member 500 may be formed as a single unit, and the single detection member 500 may individually detect the first electrode plate 10 supplied by the first supply unit 100, the second electrode plate 20 transferred by the second supply unit 200, the plurality of stages 300, and the electrode plate stack S stacked on the stage 300.

The control member 600 may generally control operations of the first supply unit 100, the second supply unit 200, and the transfer unit 400.

The control member 600 according to an embodiment may be connected to the detection member 500, and may receive information of at least one of a position, shape, size, and speed of the first electrode plate 10, the second electrode plate 20, and the stage 300 from the detection member 500. Based on the information received from the detection member 500, the control member 600 may control operations of the first supply unit 100, the second supply unit 200, and the transfer unit 400.

The control member 600 may be connected to the first supply roller 111a and may control a rotational operation of the first supply roller 111a to adjust the speed at which the first electrode plates 10 are supplied or to start or stop the supply of the first electrode plate 10.

The control member 600 may be connected to the first support member 113 and may adjust a moving direction and moving speed of the first support member 113.

The control member 600 may be connected to the second supply roller 211a and may control a rotational operation of the second supply roller 211a to adjust the speed at which the second electrode plates 20 are supplied or to start or stop the supply of the second electrode plate 20.

The control member 600 may be connected to the second support member 213 and may adjust a moving direction and moving speed of the second support member 213.

The control member 600 may be connected to the transfer roller 410 and may control a rotational operation of the transfer roller 410 to adjust a transfer speed of the stage 300 or to start or stop the transfer of the stage 300.

The control member 600 may be connected to the position adjusting member 432 and may control the driving of the position adjusting member 432 to adjust a position of the stage 300.

In an embodiment, the balancing member 431 is configured to actively rotate the stage 300, and the control member 600 may be connected to the balancing member 431 and may control the driving of the balancing member 431 to adjust a rotation angle of the stage 300.

In an embodiment, the control member 600 may be implemented as an electronic control unit (ECU), a central processing unit (CPU), a processor, or a system on chip (SoC) that is electrically connected to the first supply unit 100, the second supply unit 200, and the transfer unit 400. The control member 600 may drive an operating system or an application to control a plurality of hardware or software components and perform various types of data processing and computation. The control member 600 may be configured to execute at least one command stored in a memory and store data resulting from the execution in the memory.

Herein, an operation of the electrode plate stacking apparatus according to an embodiment of the present disclosure for stacking the first electrode plate and the second electrode plate will be described.

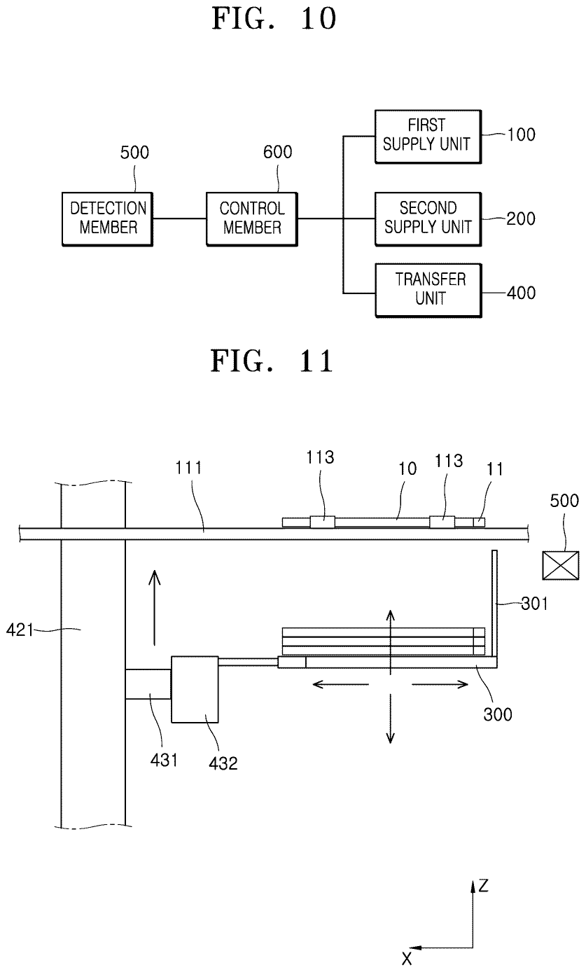

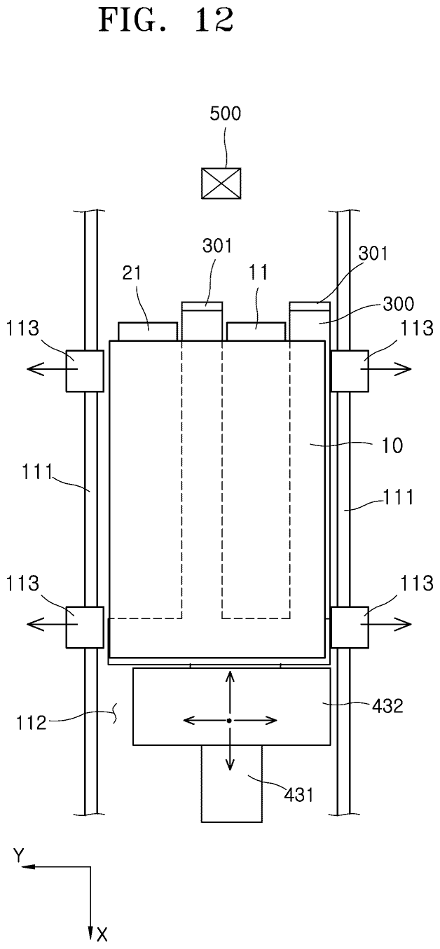

FIGS. 11 and 12 are views schematically illustrating a process in which the electrode plate stacking apparatus according to an embodiment stacks the first electrode plate and the second electrode plate.

Referring to FIGS. 1 to 12, as the control member 600 operates the first supply roller 111a and the second supply roller 211a, the first electrode plate 10 may be transferred in the second direction by the first supply rail 111, and the second electrode plate 20 may be transferred in the second direction by the second supply rail 211.

Thereafter, the control member 600 may operate the transfer roller 410, and the transfer member 420 may circulate along the circumference of the transfer roller 410.

The stage 300 transferred to the first transfer line 421 by the second transition line 424 may be moved in the first direction by the first transfer line 421, and may sequentially pass through the first rail holes 112 of the first supply conveyors 110 and the second rail holes 212 of the second supply conveyors 210, which are alternately arranged in the first direction.

As the stage 300 passes through the first rail hole 112, the first electrode plate 10 supplied onto the stage 300 by the first supply rail 111 may be stacked on the stage 300.

In this process, if a relative position of the stage 300 with respect to the first electrode plate 10 is misaligned, or if a transfer speed of the stage 300 with respect to that of the first electrode plate 10 is outside of a set range, the control member 600 may control the operation of the position adjusting member 432 such that the stage 300 is located in a correct position.

Further, the control member 600 may move the pair of first support members 113 in directions away from each other such that the first electrode plate 10 is separated from the first supply rail 111.

Thereafter, as the stage 300 passes through the second rail hole 212, the second electrode plate 20 supplied onto the stage 300 by the second supply rail 211 may be stacked on the first electrode plate 10.

In this process, if a relative position of the stage 300 with respect to the second electrode plate 20 is misaligned, or if a transfer speed of the stage 300 with respect to that of the second electrode plate 20 is outside of a set range, the control member 600 may control the operation of the position adjusting member 432 such that the stage 300 is located in a correct position.

Further, the control member 600 may move the pair of second support members 213 in directions away from each other such that the second electrode plate 20 is separated from the second supply rail 211.

The above-described process may be repeatedly performed until the stage 300 reaches the first transition line 423, and the electrode plate stack S in which the first electrode plates 10 and the second electrode plates 20 are alternately stacked on the stage 300 may be formed on the stage 300.

In an embodiment, the above process may be sequentially performed for each of the stages 300, and different electrode plate stacks S may be formed on the respective stages 300.

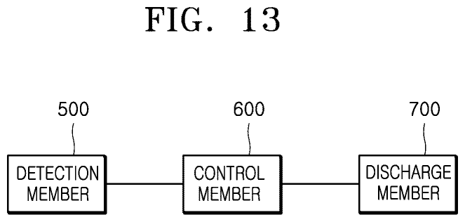

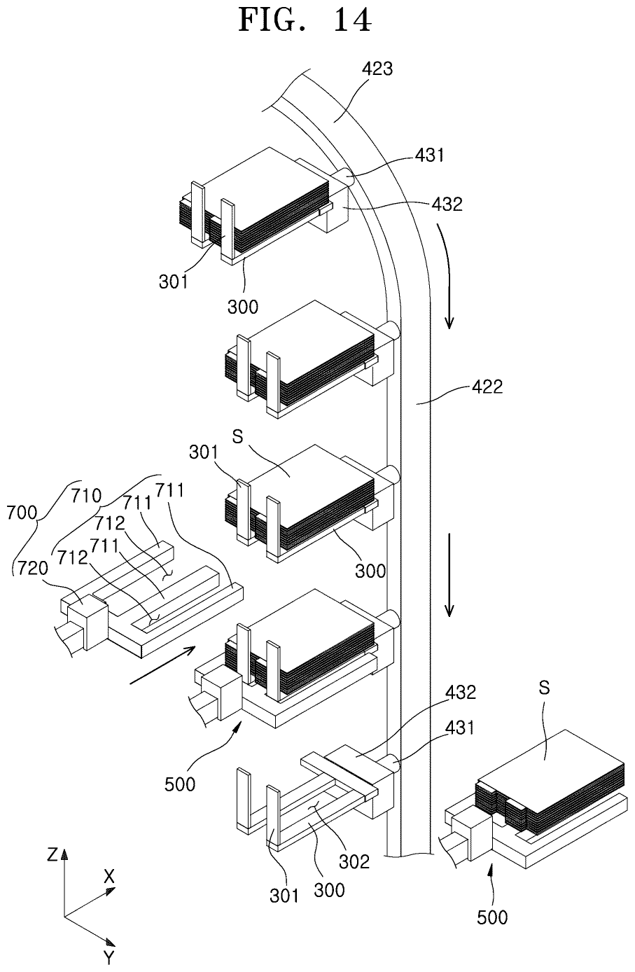

FIG. 13 is a block diagram schematically illustrating a configuration of a discharge member according to an embodiment of the present disclosure; and FIG. 14 is a perspective view schematically illustrating a configuration of the discharge member according to an embodiment of the present disclosure.

Referring to FIGS. 13 and 14, the electrode plate stacking apparatus according to an embodiment may further include a discharge member 700.

The discharge member 700 may discharge the electrode plate stack S formed on the stage 300 while passing through the first supply unit 100 and the second supply unit 200.

In an embodiment, a plurality of discharge members 700 may be provided. Each of the discharge members 700 may individually discharge the electrode plate stack S formed on a different stage 300.

The discharge member 700 according to an embodiment may include a gripper 710 and a gripper transfer member 720.

The gripper 710 may separate the electrode plate stack S from the stage 300, which is transferred in a direction opposite to the first direction by the second transfer line 422.

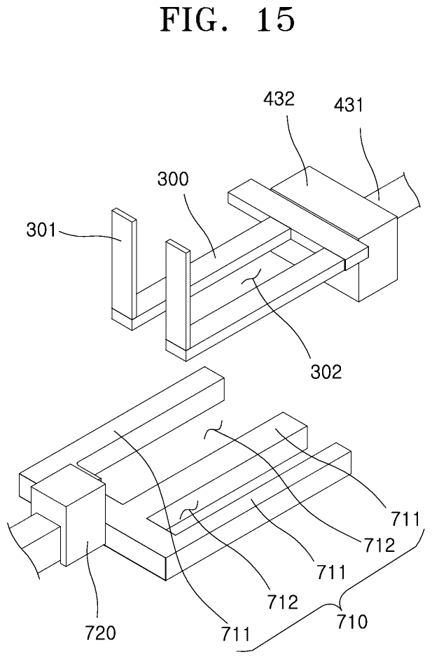

FIG. 15 is a perspective view schematically illustrating a configuration of the gripper according to an embodiment of the present disclosure.

Referring to FIGS. 14 and 15, the gripper 710 according to an embodiment may include a fork portion 711.

The fork portion 711 may support the electrode plate stack S separated from the stage 300.

The fork portion 711 according to an embodiment may be disposed parallel to the stage 300 and may have a form of a rod extending in the second direction. In an embodiment, a plurality of fork portions 711 may be provided. The plurality of fork portions 711 may be arranged at intervals (e.g., predetermined intervals) in the third direction. However, a number of fork portions 711 is not limited to that illustrated in FIG. 15 and may be varied in design.

The gripper 710 according to an embodiment may further include a gripper hole 712.

The gripper hole 712 may be, for example, an empty space disposed between a pair of fork portions 711 adjacent in the third direction. A plurality of gripper holes 712 may be provided. Each of the gripper holes 712 may be individually disposed between different pairs of fork portions 711.

The stage 300 according to an embodiment may further include a stage hole 302.

The stage hole 302 may have a shape of a hole that passes through the stage 300 in the first direction. A longitudinal direction of the stage hole 302 may be disposed parallel to the second direction. The stage 300 according to an embodiment may be divided into a pair based on the stage hole 302.

When the gripper 710 enters a lower side of the stage 300, at least one of the plurality of fork portions 711 may be disposed to face the stage hole 302 in the first direction. In an embodiment, an area of the fork portion 711 may be smaller than an area of the stage hole 302.

As an example, as shown in FIG. 15, when the gripper 710 enters the lower side of the stage 300, the fork portion 711 located at the center among three fork portions 711 may be disposed to face the stage hole 302 in the first direction, and the remaining pair of fork portions 711 may be disposed to face outer spaces of the stage 300.

When the gripper 710 enters the lower side of the stage 300, the gripper holes 712 may be respectively disposed to face divided regions of the stage 300, which are located on both, or opposite, sides of the stage hole 302. An area of the gripper hole 712 may be larger than that of the divided region of the stage 300.

The gripper transfer member 720 may be connected to the gripper 710 and may transfer the gripper 710.

The gripper transfer member 720 according to an embodiment may include any of various types of transfer devices capable of varying the position of the gripper 710, such as any of linear movement devices including ball screws, lead screws, or cylinders, and multi-axis movement devices such as a robot arm.

The control member 600 according to an embodiment may control the operation of the discharge member 700 based on position and speed information of the electrode plate stack S detected by the detection member 500.

As an example, the control member 600 may be connected to the gripper transfer member 720 and may adjust a position of the gripper 710 based on the position and speed information of the electrode plate stack S detected by the detection member 500.

Herein, a process of discharging the electrode plate stack according to an embodiment of the present disclosure will be described.

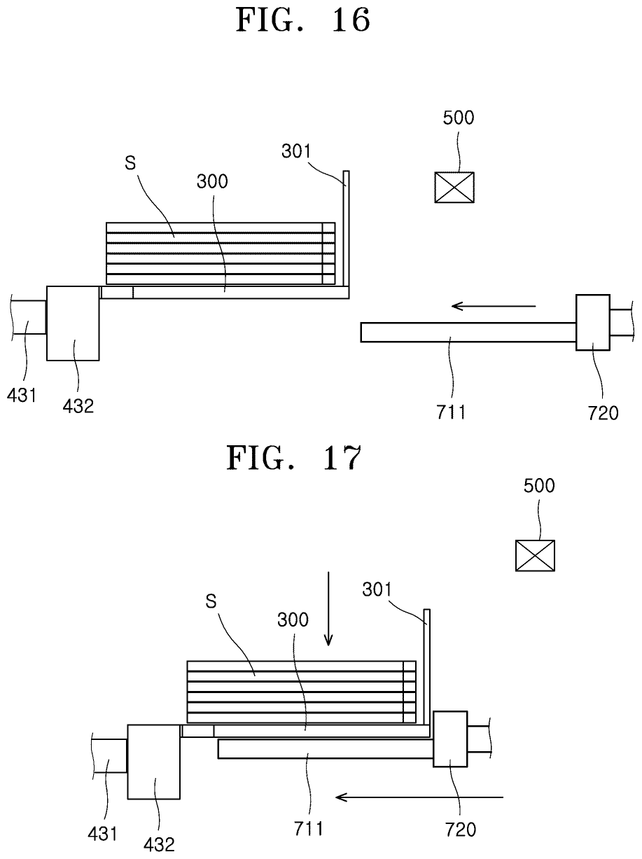

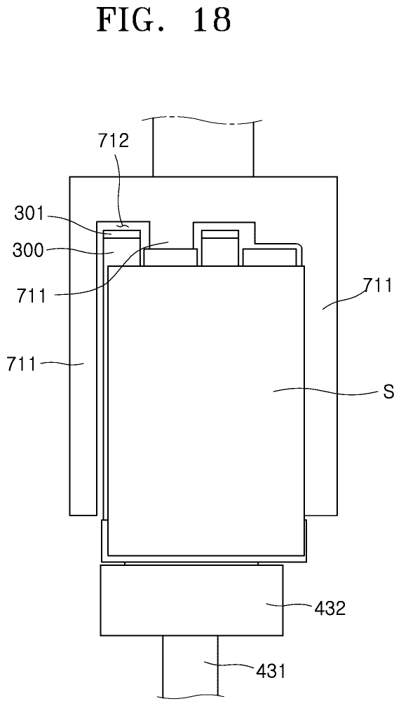

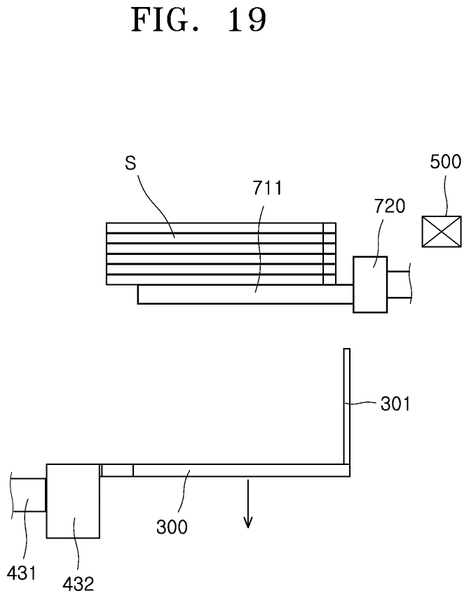

FIGS. 16 to 19 are views schematically illustrating a process in which the electrode plate stacking apparatus according to an embodiment of the present disclosure discharges the electrode plate stack.

Referring to FIGS. 14 to 19, the stage 300, which has passed through the plurality of first supply conveyors 110 and the plurality of second supply conveyors 210, may be transferred to the second transfer line 422 by the first transition line 423 and then moved in a direction opposite to the first direction by the second transfer line 422.

Thereafter, the control member 600 may control the operation of the gripper transfer member 720 based on the information on the electrode plate stack S detected by the detection member 500.

If a height of the electrode plate stack S stacked on the stage 300 is less than or equal to a set height, the control member 600 may control the operation of the gripper transfer member 720 such that the gripper 710 is not moved.

Accordingly, the stage 300 may be transferred again to the first transfer line 421 without discharging the electrode plate stack S, and the process of stacking the first electrode plate 10 and the second electrode plate 20 described above may be performed again.

If the height of the electrode plate stack S stacked on the stage 300 exceeds the set height, the control member 600 may control the operation of the gripper transfer member 720 such that the gripper 710 enters the lower side of the stage 300.

As the gripper 710 enters the lower side of the stage 300, the fork portion 711 may be disposed to face the stage hole 302, and the divided regions of the stage 300 may be disposed to face the gripper holes 712.

Thereafter, as the stage 300 continues to move in a direction opposite to the first direction, the fork portion 711 may pass through the stage hole 302, and the divided regions of the stage 300 may pass through the gripper holes 712.

During the process in which the fork portion 711 passes through the stage hole 302, a lower surface of the electrode plate stack S may be seated on the fork portion 711.

Accordingly, the electrode plate stack S may be separated from the stage 300 without moving together with the stage 300 in the direction opposite to the first direction.

Thereafter, the gripper 710 may be moved outward from the stage 300, and the electrode plate stack S seated on the gripper 710 may be transferred to a post-processing line through movement of the gripper 710 or by a separate transfer device.

In an embodiment, the above process may be performed independently by each of the discharge members 700 for the respective stages 300 transferred along the second transfer line 422.

According to one or more embodiments of the present disclosure, by continuously transferring a stage, a stacking operation can be performed in which a first electrode plate and a second electrode plate, supplied from different positions, are stacked, thereby reducing process time and improving process efficiency.

According to one or more embodiments of the present disclosure, as a stage repeatedly circulates along a certain (e.g., predetermined) path, a stacking height of first and second electrode plates can be increased without increasing the number of first and second supply conveyors.

However, aspects and effects obtainable through the present disclosure are not limited to the above aspects and effects, and other aspects and technical effects that are not mentioned will be clearly understood by those skilled in the art from the description of the present disclosure.

While the present disclosure has been described with reference to some embodiments shown in the drawings, these embodiments are merely illustrative and it is to be understood that various modifications and equivalent other embodiments can be derived by those skilled in the art on the basis of the embodiments.

What is claimed is:

1. An electrode plate stacking apparatus comprising:
a first supplier configured to supply a first electrode plate;
a second supplier spaced apart from the first supplier and configured to supply a second electrode plate;
a stage configured to sequentially pass through the first supplier and the second supplier such that the first electrode plate and the second electrode plate are alternately stacked; and
a transferer connected to the stage and configured to transfer the stage.

2. The electrode plate stacking apparatus as claimed in claim 1, wherein the transferer comprises:
a transfer roller;
a transfer member arranged to surround the transfer roller and configured to circulate along a circumference of the transfer roller; and
a connection member configured to connect the transfer member and the stage.

3. The electrode plate stacking apparatus as claimed in claim 2, wherein the stage comprises a plurality of stages arranged along a movement path of the transfer member.

4. The electrode plate stacking apparatus as claimed in claim 2, wherein the transfer member comprises a first transfer line configured to transfer the stage in a first direction, and
the first supplier comprises a plurality of first supply conveyors configured to supply the first electrode plate onto the stage transferred in the first direction.

5. The electrode plate stacking apparatus as claimed in claim 4, wherein the plurality of first supply conveyors are arranged in the first direction.

6. The electrode plate stacking apparatus as claimed in claim 4, wherein each of the first supply conveyors comprises:
a pair of first supply rails configured to transfer the first electrode plate in a second direction intersecting the first direction; and
a first rail hole located between the pair of first supply rails,
the stage passes through the first rail hole in the first direction, and
the first electrode plate is stacked on the stage that has passed through the first rail hole.

7. The electrode plate stacking apparatus as claimed in claim 6, wherein the first transfer line is located inside the first rail hole.

8. The electrode plate stacking apparatus as claimed in claim 6, wherein each of the first supply conveyors further comprises first support members extending from the first supply rails toward the first rail hole and configured to support the first electrode plate.

9. The electrode plate stacking apparatus as claimed in claim 8, wherein the pair of first supply rails face each other in a third direction intersecting the first direction and the second direction, and
the first support members are movably connected to the first supply rails in the third direction and a direction opposite to the third direction.

10. The electrode plate stacking apparatus as claimed in claim 4, wherein the second supply unit comprises a plurality of second supply conveyors configured to supply the second electrode plate onto the stage transferred in the first direction.

11. The electrode plate stacking apparatus as claimed in claim 10, wherein the plurality of second supply conveyors are arranged in the first direction.

12. The electrode plate stacking apparatus as claimed in claim 10, wherein the first supply conveyors and the second supply conveyors are alternately arranged in the first direction.

13. The electrode plate stacking apparatus as claimed in claim 10, wherein each of the second supply conveyors comprises:
a pair of second supply rails configured to transfer the second electrode plate in a second direction intersecting the first direction; and
a second rail hole located between the pair of second supply rails,
the stage passes through the second rail hole in the first direction, and
the second electrode plate is stacked on the stage that has passed through the second rail hole.

14. The electrode plate stacking apparatus as claimed in claim 13, wherein each of the second supply conveyors further comprises second support members extending from the second supply rails toward the second rail hole and configured to support the second electrode plate.

15. The electrode plate stacking apparatus as claimed in claim 2, wherein the connection member comprises a balancing member configured to rotatably support the stage with respect to the transfer member.

16. The electrode plate stacking apparatus as claimed in claim 2, wherein the connection member comprises a position adjusting member configured to adjust a position of the stage.

17. The electrode plate stacking apparatus as claimed in claim 2, wherein the first electrode plate and the second electrode plate are alternately stacked on the stage to form an electrode plate stack, and
the electrode plate stacking apparatus further comprises a discharge member configured to discharge the electrode plate stack from the stage.

18. The electrode plate stacking apparatus as claimed in claim 17, wherein the transfer member comprises:
a first transfer line configured to transfer the stage in a first direction; and
a second transfer line connected to the first transfer line and configured to transfer the stage in a direction opposite to the first direction, and
the discharge member comprises:
a gripper configured to separate the electrode plate stack from the stage transferred in the direction opposite to the first direction; and
a gripper transfer member connected to the gripper and configured to transfer the gripper.

19. The electrode plate stacking apparatus as claimed in claim 18, wherein the gripper comprises a fork portion facing a stage hole that passes through the stage in the first direction, and
as the stage is transferred in the direction opposite to the first direction, the fork portion passes through the stage hole, and the electrode plate stack is seated on the fork portion.

20. The electrode plate stacking apparatus as claimed in claim 1, further comprising:
a detector configured to detect the first electrode plate, the second electrode plate, and the stage; and
a controller configured to control operations of the first supplier, the second supplier, and the transferer based on information detected by the detection member.
